(19) United States
(12) Patent Application Publication
(10) Pub. No.: US 2008/0033630 A1
(43) Pub. Date: Feb. 7, 2008

(54) System and method of predicting traffic speed based on speed of neighboring link

(76) Inventors: Eun-Mi Lee, Gyeongsangbuk-do (KR); Sung-Hwa Lim, Gyeonggi-do (KR); Jae-Hoon Kim, Gyeonggi-do (KR); Won-Sik Yoon, Gyeonggi-do (KR); Byung-Soo Kim, Gyeonggi-do (KR)

Correspondence Address: LADAS & PARRY LLP, 224 SOUTH MICHIGAN AVENUE, SUITE 1600, CHICAGO, IL, 60604, US

(21) Appl. No.: 11/493,088

(22) Filed: Jul. 26, 2006

(51) Int. Cl. G08G 1/00; G08G 1/123

(52) U.S. Cl. 701/117; 340/995.13

(57) ABSTRACT

The present invention relates to a system and a method of predicting traffic speed based on the speeds of neighboring links. A system for predicting traffic speed on a link basis, on a map based on a past traffic patterns, includes a prediction model establishment unit that establishes a neighboring link speed-based prediction model including the correlation between the speed of each link and the speeds of neighboring links based on real-time traffic information accumulated in a real-time traffic information database for a predetermined time, a prediction model database that stores the established neighboring link speed-based prediction model data, and a traffic speed prediction unit that inputs real-time neighboring link speed information for a specific object link to the neighboring link speed-based prediction model and predicts an output value according to the real-time neighboring link speed information as the traffic speed of the object link.

### BACKGROUND OF THE INVENTION

1. Field of the Invention

The present invention relates to a system and a method of predicting traffic speed based on the speeds of neighboring links. More particularly, the present invention relates to a system and a method of predicting traffic speed based on the speeds of neighboring links, which establishes the correlation between the speeds of each link and the neighboring links based on information about past actual traffic speeds, and predicts the traffic speed of a specific link based on the established correlation using the actual speeds of the neighboring links.

2. Description of the Related Art

In recent years, traffic information has been provided in various manners for the purpose of efficient operation and management of roads, a route guide for providing vehicle drivers with convenience, and so on. To this end, various traffic speed prediction methods which collect traffic information in real-time and process and supplement the collected traffic information in order to predict traffic speed have been proposed.

The traffic speed is generally predicted based on real-time traffic information for a predetermined time. For example, there is a method of patterning the past actual traffic speed by date and time, and predicting the traffic speed for a specific time on a specific date in the future using the patterned information.

However, since the traffic speed is variable, if there is a large difference between the traffic speed relative to a specific section on a specific date to be predicted and the traffic speed of a corresponding section relative to the same date of the past week, it is impossible to predict an accurate speed when information patterned by date and time is used. To solve this problem, a method of accurately predicting the traffic speed using additional parameters, such as fog, temperature, moisture, and weather conditions, as well as the date and time , has been proposed. However, this method is disadvantageous in that it is impossible to predict an accurate speed since the parameters have little influence on the traffic speed.

Furthermore, in the case where the speed of a specific unit link on a map is to be predicted, there is a high probability that the current speed of a corresponding unit link has a connection with the speeds of the neighboring links, which are under a similar situation at the same time, rather than the past speed of the corresponding unit link. Accordingly, there is a need for a method of predicting the traffic speed using the speeds of the neighboring links.

### SUMMARY OF THE INVENTION

Accordingly, the present invention has been made in order to solve the problems inherent in the related art, and it is an object of the present invention to provide a system and a method of predicting traffic speed based on the speeds of neighboring links, which establishes the correlation between the speeds of each link and neighboring links based on information about the past actual traffic speed, and predicts the traffic speed of a specific link using the real-time speeds of the neighboring links, which are under a similar situation, based on the established correlation.

According to an aspect of the present invention, a system for predicting the traffic speed on a link basis, on a map based on past traffic patterns, includes a prediction model establishment unit that establishes a neighboring link speed-based prediction model including the correlation between the speed of each link and the speeds of neighboring links based on real-time traffic information accumulated in a real-time traffic information database for a predetermined time, a prediction model database that stores the established neighboring link speed-based prediction model data, and a traffic speed prediction unit that inputs real-time neighboring link speed information for a specific object link to the neighboring link speed-based prediction model and predicts an output value according to the input of the real-time neighboring link speed information as the traffic speed of the object link.

According to another aspect of the present invention, a method of predicting the traffic speed on a link basis, on a map based on a past traffic patterns, includes calculating the traffic speed on a link basis based on real-time traffic information accumulated for a predetermined time, deducing the correlation between the speed of each link and speeds of neighboring links, and predicting a speed of a specific object link using information about the real-time speeds of the neighboring links for the object link and the deduced correlation between them.

The above objects, technical constructions, and advantages of the present invention will be more clearly understood from the following detailed description in conjunction with the accompanying drawings.

### BRIEF DESCRIPTION OF THE DRAWINGS

FIG. 1 is a conceptual view illustrating a system and a method of predicting traffic speed according to an embodiment of the present invention;

FIG. 2 is a block diagram showing the construction of a traffic speed prediction system according to an embodiment of the present invention;

FIG. 3 shows the structure of a neuron network used to predict traffic speed according to an embodiment of the present invention; and

FIG. 4 is a flowchart sequentially illustrating a traffic speed prediction method according to an embodiment of the present invention.

### DESCRIPTION OF THE PREFERRED EMBODIMENTS

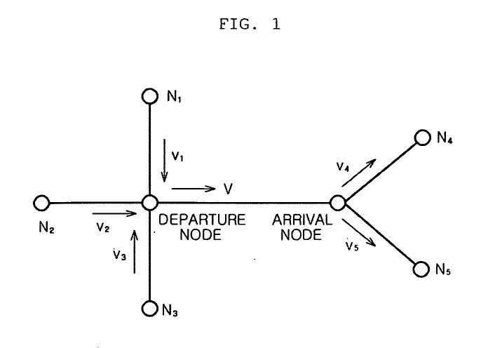

FIG. 1 is a conceptual view illustrating a system and a method of predicting traffic speed according to an embodiment of the present invention.

The traffic speed prediction system and method according to an embodiment of the present invention uses the speed information of neighboring links so as to predict the speed of a specific object link. To this end, in the present invention, the correlation between an object link and neighboring links is deduced based on traffic information accumulated for a past predetermined time and is databased. If it is desired to predict the speed of a specific object link at a specific time, the speed of the object link close to an actual traffic speed is predicted using the databased correlation and the speeds of neighboring links at the specific time.

As shown in FIG. 1, the neighboring links of an object link, connecting a departure node and an arrival node, includes links from nodes N1, N2, and N3 adjacent to the departure node and links from the arrival node to nodes N4 and N5 adjacent to the arrival node.

In this case, at the time of predicting the speed V of an object link between the departure node and the arrival node, actual real-time speeds v₁ to v₅ of the neighboring links of the object link are used in the present invention. To this end, the correlation between the real-time speed of the object link that was accumulated in the past and the real-time speeds of the neighboring links at the same time needs to be deduced.

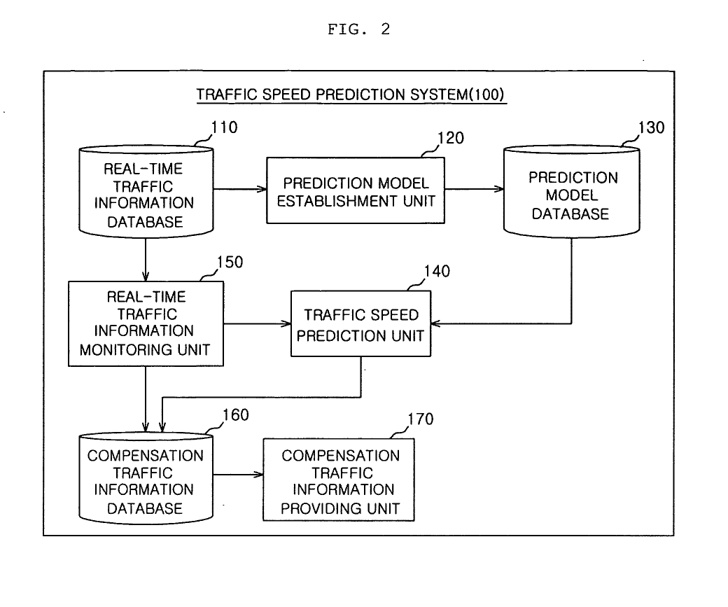

The deduction of the correlation can be performed through learning using a neuron network having a number of input neurons and one output neuron. The present invention will be described in detail with reference to FIGS. 2 to 4.

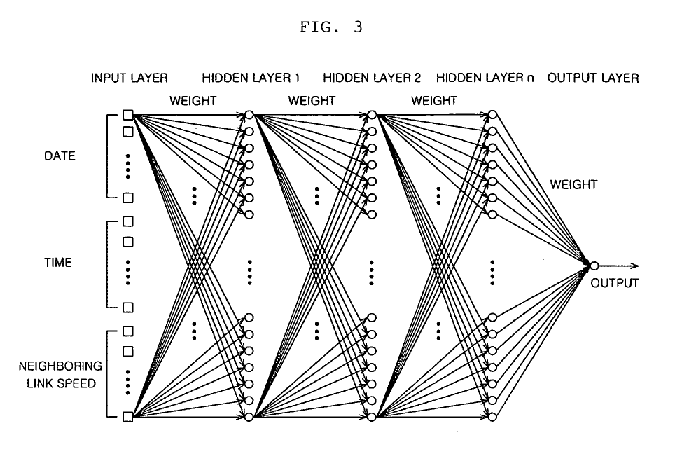

FIG. 2 is a block diagram showing the construction of a traffic speed prediction system according to an embodiment of the present invention. FIG. 3 shows the structure of a neuron network used to predict traffic speed according to an embodiment of the present invention.

Referring to FIG. 2, the traffic speed prediction system 100 of the present invention includes a real-time traffic information database 110, a prediction model establishment unit 120, a prediction model database 130, and a traffic speed prediction unit 140. The traffic speed prediction system 100 may further include a real-time traffic information monitoring unit 150, a compensation traffic information database 160, a compensation traffic information providing unit 170, and the like.

The real-time traffic information database 110 serves to accumulate and store information, which is collected from a vehicle whose position can be tracked, such as a taxi, using a method of receiving real-time positional information, or the like. The stored information is used to predict traffic speed or to provide real-time traffic information.

The prediction model establishment unit 120 serves to establish a neighboring link speed-based prediction model including a correlation between the speed of each link and the speeds of neighboring links based on real-time traffic information accumulated in the real-time traffic information database 110 for a predetermined time.

The neighboring link speed-based prediction model can be established using a neuron network learning method. In the present invention, the neuron network may include an input layer having a plurality of input neurons for receiving a plurality of neighboring link speeds for a specific object link as inputs, and an output layer having one output neuron for outputting the object link speed as an output.

In general, the neuron network is based on a delta rule. If a number of neuron networks provide each neuron of the input layer with an input pattern, a signal corresponding to the input pattern is converted in each neuron and is transmitted to a hidden layer (that is, an intermediate layer). Finally, the output layer outputs a final signal. A connection strength between respective layers is controlled in such a manner that a difference between the final signal, that is the output value, and a target value is reduced by comparison. A connection strength controlled in an upper layer is inversely propagated, and a lower layer can control its connection strength based on the propagated connection strength. This process is called the delta rule. The neuron network model has already been known in the art and will not be described in detail.

In the present invention, it has been described that the traffic speed of a specific object link is predicted based on the real-time speeds of neighboring links. However, the deduction of the correlation between the links may be different depending on the date and time. Therefore, the input layer of the neuron network may further include a plurality of input neurons using the date and time as inputs, as shown in FIG. 3.

Meanwhile, as described above with reference to the neuron network principle, it is common that one or more hidden layers are included between the input layer and the output layer of the neuron network. The hidden layers exist so as to reduce an error rate between an actual value (a value of an object link speed) and a prediction value (an output value of the neighboring link speed-based prediction model). With an input value input to each neuron of the input layer, one output value is calculated through the calculation with a weight deduced between neighboring layers at the time of establishing the model. Therefore, the more the number of the hidden layers, the higher the probability that the output value calculated through the neuron network may approach the actual value.

Meanwhile, the established neighboring link speed-based prediction model data are stored in the prediction model DB 130. The traffic speed prediction unit 140 inputs the neighboring link real-time speed information for a specific object link to the neighboring link speed-based prediction model based on the information of the database 130 and predicts an output value according to the input of the neighboring link real-time speed information as the traffic speed of the object link.

Meanwhile, the traffic speed prediction unit 140 can predict traffic speed if various external service servers or navigation devices request the speed of a specific object link and provide a predicted speed. As shown in FIG. 2, the traffic speed prediction system 100 may include the real-time traffic information monitoring unit 150 that monitors information accumulated in the real-time traffic information database 110 in real-time. The traffic speed prediction unit 140 may serve to compensate for omitted information when there is a link having omitted information due to a failure in a collection device or the like.

The real-time traffic information monitoring unit 150 monitors the real-time traffic information accumulated in the real-time traffic information database 110 and stores a statistical value of a link-based traffic speed in the compensation traffic information database 160. If it is impossible to collect traffic information about a specific object link from the real-time traffic information database 110, the real-time traffic information monitoring unit 150 may transmit information about a corresponding object link and information about the speeds of neighboring links to the traffic speed prediction unit 140 in order to request the traffic speed prediction unit 140 to predict a traffic speed.

The traffic speed prediction unit 140 inputs the neighboring link speed information, which is received from the real-time traffic information monitoring unit 150, to the neighboring link speed-based prediction model using the prediction model database 130 and stores an output value according to the input of the neighboring link speed information in the compensation traffic information database 160 as the traffic speed of the object link.

The traffic speed information stored in the compensation traffic information database 160 in such a manner can be provided to the outside by the compensation traffic information providing unit 170 that provides compensated traffic information to various traffic information-related service servers, navigation devices, and the like.

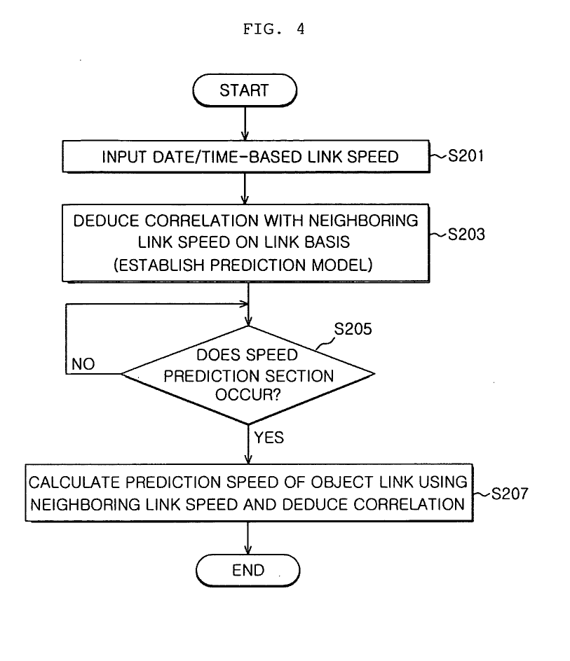

FIG. 4 is a flowchart sequentially illustrating a traffic speed prediction method according to an embodiment of the present invention. The traffic speed prediction method of predicting traffic speed on a link basis, on a map based on a past traffic patterns, using the speeds of neighboring links according to an embodiment of the present invention will be sequentially described below.

The traffic speed prediction system 100 of the present invention first calculates the traffic speed on a date/time basis based on real-time traffic information accumulated in the real-time traffic information database 110 for a predetermined time (Step S201).

The traffic speed prediction system 100 then establishes a prediction model by deducing the correlation between the speed of each link and the speeds of neighboring links on the basis of the same time (date/time) (Step S203).

In the case where the neuron network learning method is used, the traffic speed prediction system 100 may use a neuron network structure including an input layer having a plurality of input neurons for receiving neighboring link speeds as inputs, one or more hidden layers, and an output layer having one output neuron. The traffic speed prediction system 100 establishes the prediction model by learning the past traffic information and calculating the weight of the neuron network in such a manner that it inputs the speeds of the neighboring links to each input neuron of the input layer and inputs the speed of the object link, at a time at which the input speeds of the neighboring links are calculated, to the output neuron of the output layer.

The prediction model established as described above needs to be updated depending on variations in various environments, such as road situations or the like. It is therefore preferable that Steps S201 and S203 are repeated cyclically.

After the prediction model is established as described above, if a section whose speed needs to be predicted at the time of monitoring traffic information or a request from the outside occurs (Step S205), the traffic speed prediction system 100 acquires the real-time speed information of neighboring links for a corresponding section (an object link) at a time at which prediction needs to be performed, and inputs an output value as the speed of the object link using the real-time speed values of the neighboring links as input values of the prediction model (Step S207).

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

As described above, in accordance with a system and a method of predicting traffic speed based on neighboring link speeds according to the present invention, the correlation between the speed of each link and the speeds of neighboring links is established based on the past actual traffic speed information. Therefore, the present invention is advantageous in that it can predict traffic speed more accurately using the real-time speeds of neighboring links, which are under a similar situation to a specific prediction object link, at a specific time at which prediction will be preformed.

What is claimed is:

1. A system for predicting traffic speed on a link basis, on a map based on a past traffic patterns, the system comprising:
a prediction model establishment unit that establishes a neighboring link speed-based prediction model including the correlation between a speed of each link and speeds of neighboring links based on real-time traffic information accumulated in a real-time traffic information database for a predetermined time;
a prediction model database that stores the established neighboring link speed-based prediction model data; and
a traffic speed prediction unit that inputs real-time neighboring link speed information for a specific object link to the neighboring link speed-based prediction model and predicts an output value according to the input of the real-time neighboring link speed information as a traffic speed of the object link.

2. The system of claim 1,
wherein the prediction model establishment unit establishes the neighboring link speed-based prediction model by learning using a neuron network including an input layer having a plurality of input neurons for receiving a plurality of neighboring link speeds for a specific object link as inputs, and an output layer having one output neuron for outputting the object link speed as an output.

3. The system of claim 1,
wherein the prediction model establishment unit establishes the neighboring link speed-based prediction model by learning using a neuron network including an input layer having a plurality of input neurons for receiving a plurality of neighboring link speeds, a date, and a time for a specific object link as inputs, and an output layer having one output neuron for outputting the object link speed as an output.

4. The system of claim 2,
wherein the neuron network further includes one or more hidden layers interposed between the input layer and the output layer in order to reduce an error rate between an output value of the neighboring link speed-based prediction model and an actual value of the object link speed.

5. The system of claim 1, further comprising:
a real-time traffic information monitoring unit that monitors the real-time traffic information accumulated in the real-time traffic information database, stores a statistical value of a traffic speed in a compensation traffic information database and, if it is impossible to collect traffic information of a specific object link from the real-time traffic information database, transmits information about a corresponding object link and information about neighboring link speeds to the traffic speed prediction unit in order to request the traffic speed prediction unit to predict a traffic speed,
wherein the traffic speed prediction unit inputs the neighboring link speed information, which is received from the real-time traffic information monitoring unit, to the neighboring link speed-based prediction model and stores an output value according to the input of the neighboring link speed information in the compensation traffic information database as the traffic speed of the object link.

6. The system of claim 1,
wherein the neighboring links include one or more unit links using a departure node of an object link as an arrival node and one or more unit links using an arrival node of the object link as a departure node, for the object link from a specific departure node to a specific arrival node.

7. A method of predicting traffic speed on a link basis, on a map based on a past traffic patterns, the method comprising:
calculating a traffic speed on a link basis based on real-time traffic information accumulated for a predetermined time;
deducing the correlation between a speed of each link and speeds of neighboring links; and
predicting a speed of a specific object link using information about real-time speeds of neighboring links for the object link and the correlation deduced in the second step.

8. The method of claim 7,
wherein the deducing of the correlation establishes a neighboring link speed-based prediction model by learning using a neuron network including an input layer having a plurality of input neurons for receiving a plurality of neighboring link speeds for a specific object link as inputs, and an output layer having one output neuron for outputting the object link speed as an output.

9. The method of claim 7,
wherein the deducing of the correlation establishes a neighboring link speed-based prediction model by learning using a neuron network including an input layer having a plurality of input neurons for receiving a plurality of neighboring link speeds, a date, and a time for a specific object link as inputs, and an output layer having one output neuron for outputting the object link speed as an output.

10. The method of claim 8,
wherein the neuron network further includes one or more hidden layers interposed between the input layer and the output layer in order to reduce an error rate between an output value of the neighboring link speed-based prediction model and an actual value of the object link speed.

11. The method of claim 7,
wherein the neighboring links include one or more unit links using a departure node of an object link as an arrival node and one or more unit links using an arrival node of the object link as a departure node, for the object link from a specific departure node to a specific arrival node.

12. The system of claim 3,
wherein the neuron network further includes one or more hidden layers interposed between the input layer and the output layer in order to reduce an error rate between an output value of the neighboring link speed-based prediction model and an actual value of the object link speed.

13. The method of claim 9,
wherein the neuron network further includes one or more hidden layers interposed between the input layer and the output layer in order to reduce an error rate between an output value of the neighboring link speed-based prediction model and an actual value of the object link speed.
